(19) United States
(12) Patent Application Publication
(10) Pub. No.: US 2011/0176174 A1
(43) Pub. Date: Jul. 21, 2011

(54) IMAGE PROCESSING APPARATUS, CONTROL METHOD FOR IMAGE PROCESSING APPARATUS, AND STORAGE MEDIUM

(75) Inventor: Yoshihide Terao, Yokohama-shi (JP)

(73) Assignee: CANON KABUSHIKI KAISHA, Tokyo (JP)

(21) Appl. No.: 13/056,576

(22) PCT Filed: Aug. 6, 2009
(86) PCT No.: PCT/JP2009/003788

§ 371 Date: Jan. 28, 2011

(30) Foreign Application Priority Data
Aug. 21, 2008 (JP) 2008-212938

(51) Int. Cl. G06F 3/12; G06K 15/02

(52) U.S. Cl. 358/1.15; 358/1.16

(57) ABSTRACT

At least one of a plurality of images included in a single file is specified in accordance with an operation by a user, and another image is selected from among the plurality of images based on the type of the specified image. At least one of the specified image and the selected other image is output.

### TECHNICAL FIELD

The present invention relates to an image processing apparatus that outputs an image selected from among a plurality of images included in a single file, a control method for the image processing apparatus, and a storage medium.

### BACKGROUND ART

Multifunction peripherals (MFPs) that output an image selected by a user from among a plurality of received images are known.

Such an MFP receives an image by using a method of receiving image data from a host computer connected to the MFP, acquiring image data generated when a scanner included in the MFP reads an original, reading image data stored in a portable memory medium, or the like.

Then, the MFP stores the received image in a hard disk included in the MFP, and displays a list of images stored in the hard disk on a display unit in accordance with an instruction from a user so that the user can select a desired image from among the images displayed on the display unit.

When the desired image is selected by the user, the MFP outputs the selected image by using a method of transmitting image data to an external apparatus via a network, writing image data in a portable memory medium, or the like.

In recent years, a format in which a single file includes a plurality of images has been known. A technique for storing images of different resolutions as a single file and selecting an image to be displayed from among the images in accordance with a display area of a display device on which the image is to be displayed, is disclosed, for example, in Patent Literature 1.

In the case of a format in which a single file includes a plurality of images, there might be problems when an image selected by a user from among a plurality of images included in a single file is output, as described below.

That is, in a case where a user desires a large number of images to be output, the user needs to perform operations for specifying individual images one by one.

In addition, in a case where a user forgets to select an image to be output, the un-selected image cannot be output. Thus, in a case where after an image is output, a user becomes aware that another image to be output has not been output, the user needs to perform an operation for specifying the image so that the image can be output, thereby requiring time and effort.

Furthermore, such a user operation for selecting an image becomes more complicated in a case where a single file includes images of different types.

For example, in the case of a panoramic image, which is constituted by a plurality of partial panoramic images, when only one of the plurality of partial panoramic images is output, the original panoramic image cannot be obtained. Thus, in order to obtain the original panoramic image, a user needs to select and specify the plurality of partial panoramic images constituting the original panoramic image.

However, in a case where a single file includes a plurality of images, it is not easy to correctly select and specify necessary partial panoramic images. In addition, in a case where a user does not know that it is necessary to select a plurality of partial panoramic images, the necessary partial panoramic images cannot be selected.

Alternatively, in a case where a single file includes a thumbnail image and the original image of the thumbnail image, a user might desire only the original image to be output, without the thumbnail image being output.

However, in this case, for selection of an image, the user needs to understand whether or not each image is a thumbnail image or understand which thumbnail image is associated with an image. Thus, the user needs to perform a complicated operation.

### CITATION LIST

### Patent Literature

PTL 1: Japanese Patent Laid-Open No. 2002-149153

### SUMMARY OF INVENTION

The present invention provides a mechanism for selecting and outputting, in accordance with the type of an image specified by a user, a different image of a type corresponding to the type of the specified image from among a plurality of images included in a single file.

The present invention provides an image processing apparatus, a control method for the image processing apparatus, and a storage medium which overcome the above-described problems.

According to an aspect of the present invention, there is provided an image processing apparatus including an image specifying unit configured to specify at least one of a plurality of images included in a single file in accordance with an operation by a user; an image selecting unit configured to select, in accordance with the type of the at least one image specified by the image specifying unit, another image from among the plurality of images based on the type of the specified at least one image; and an output unit configured to output at least one of the at least one image specified by the image specifying unit and the other image selected by the image selecting unit.

Further feature of the present invention will become apparent from the following detailed description of exemplary embodiments with reference to the attached drawings.

### BRIEF DESCRIPTION OF DRAWINGS

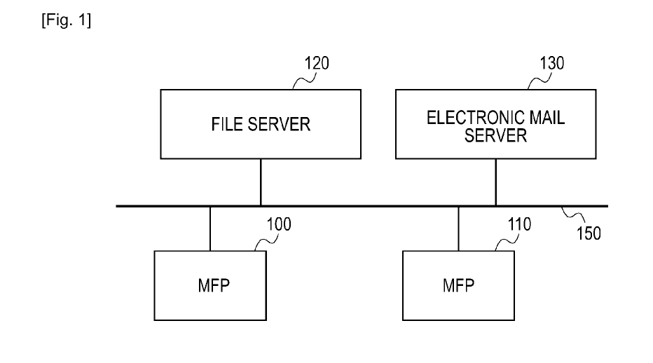

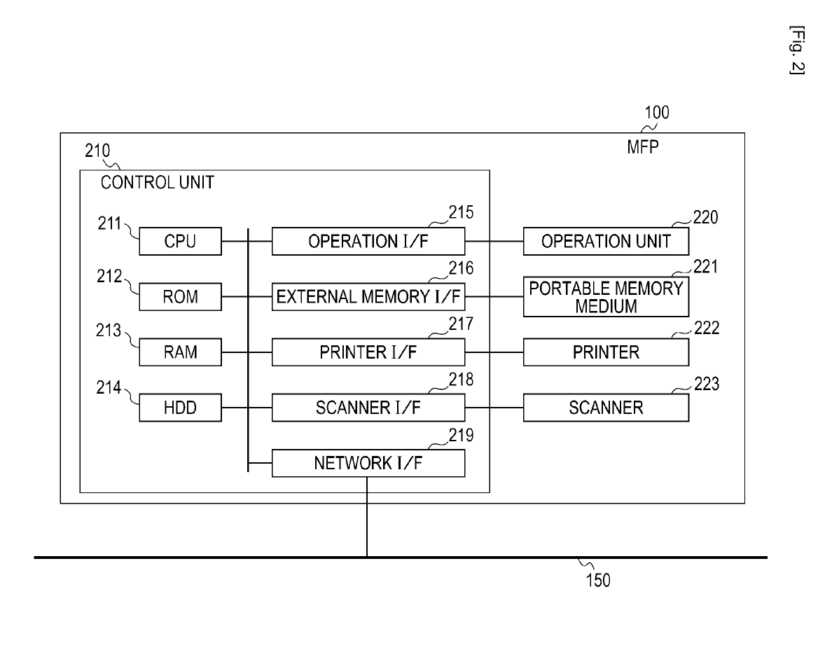

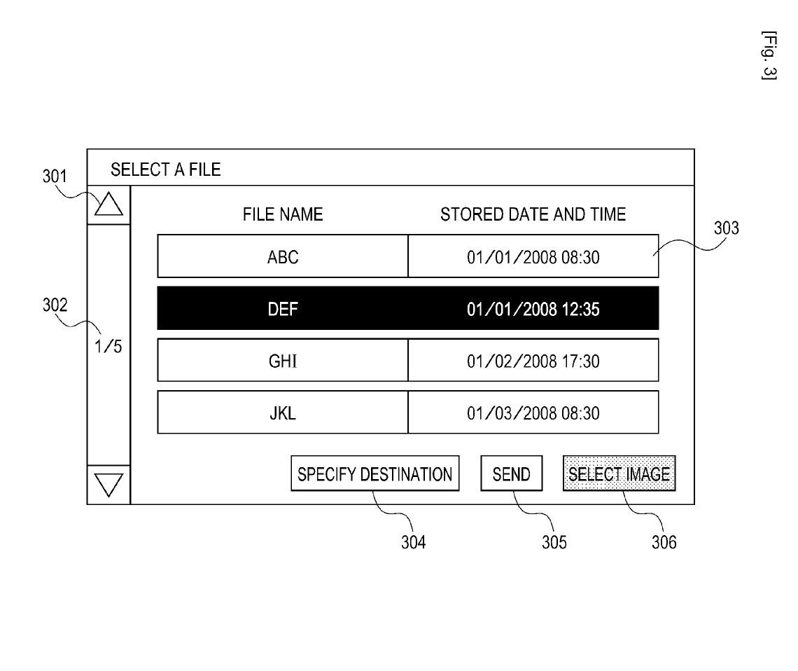

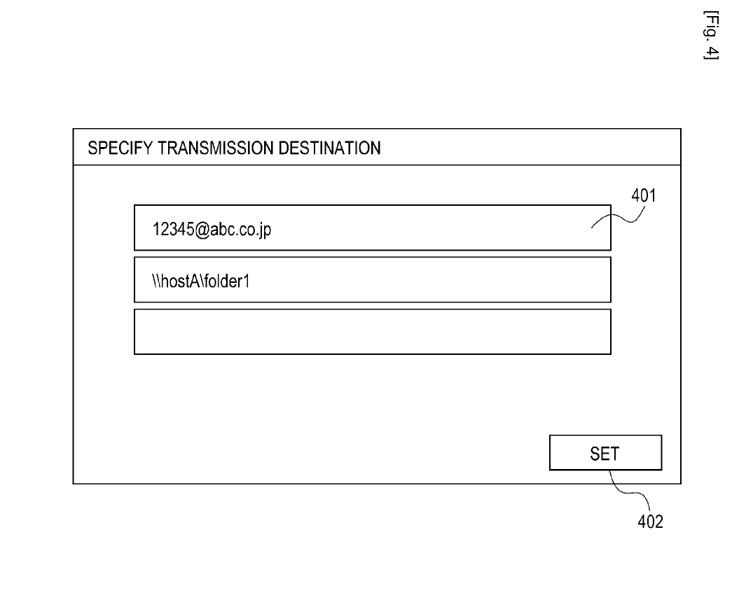

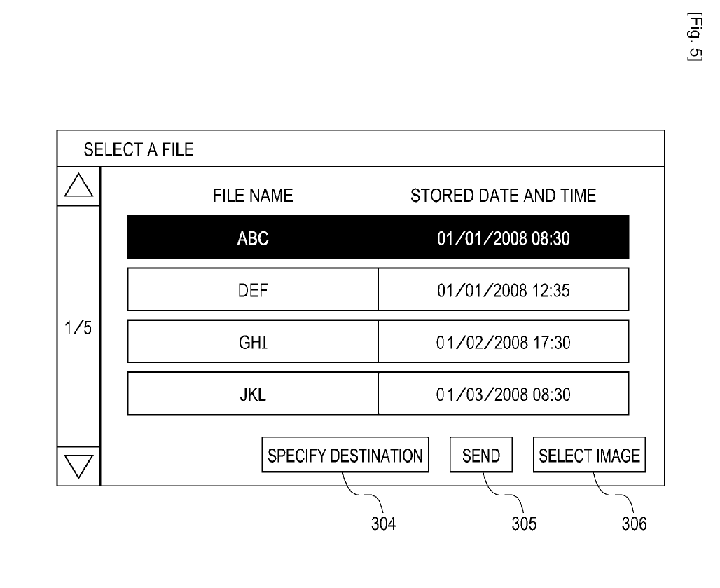

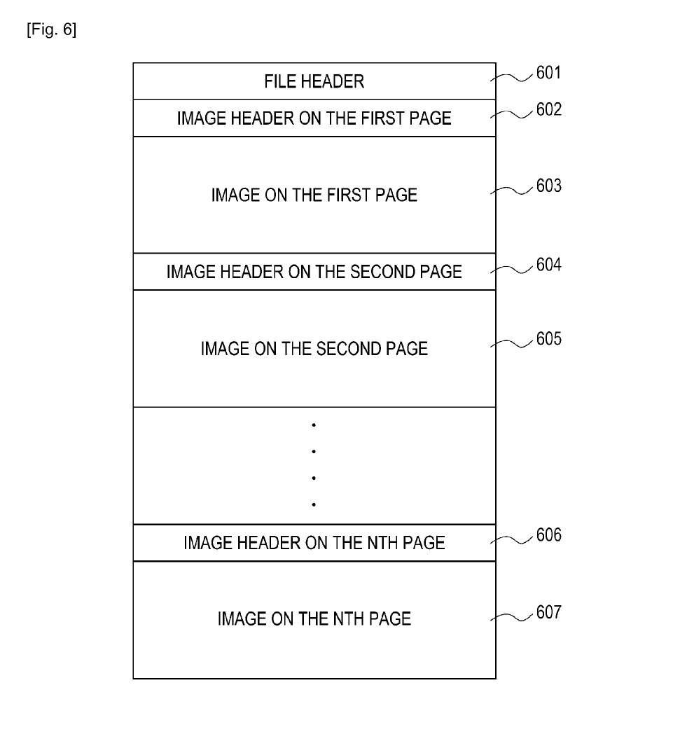

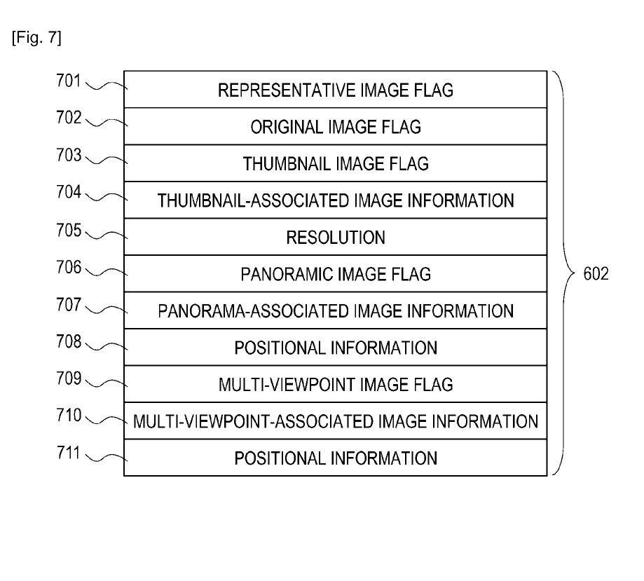

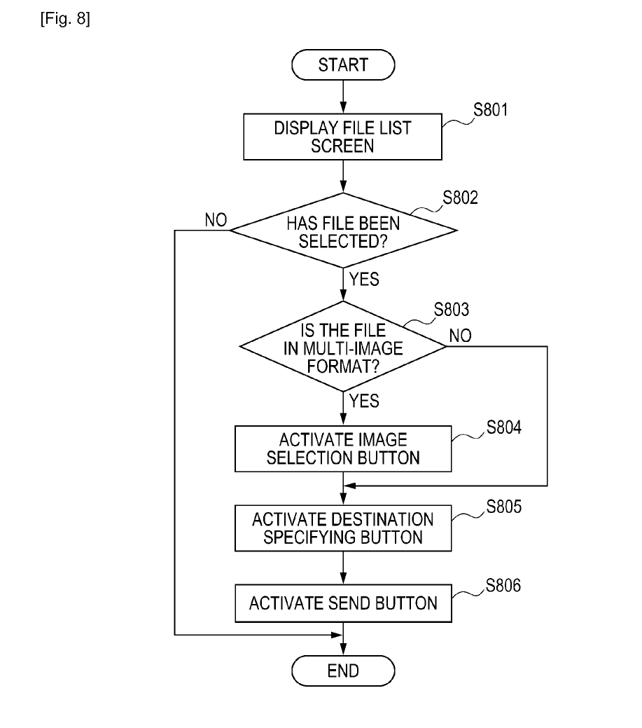

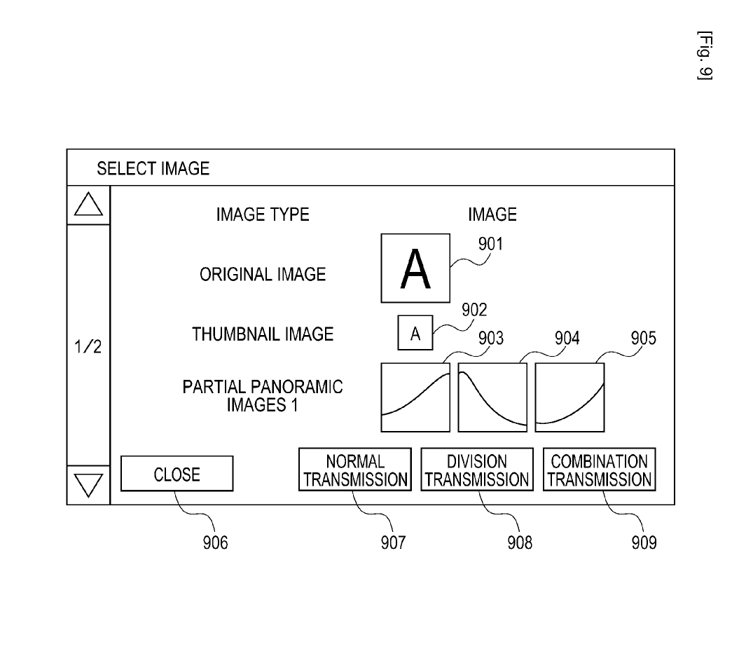

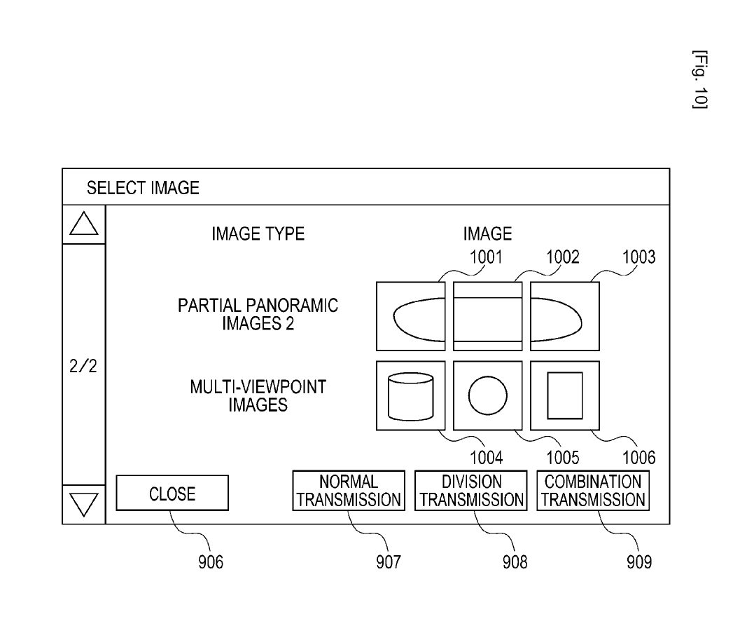

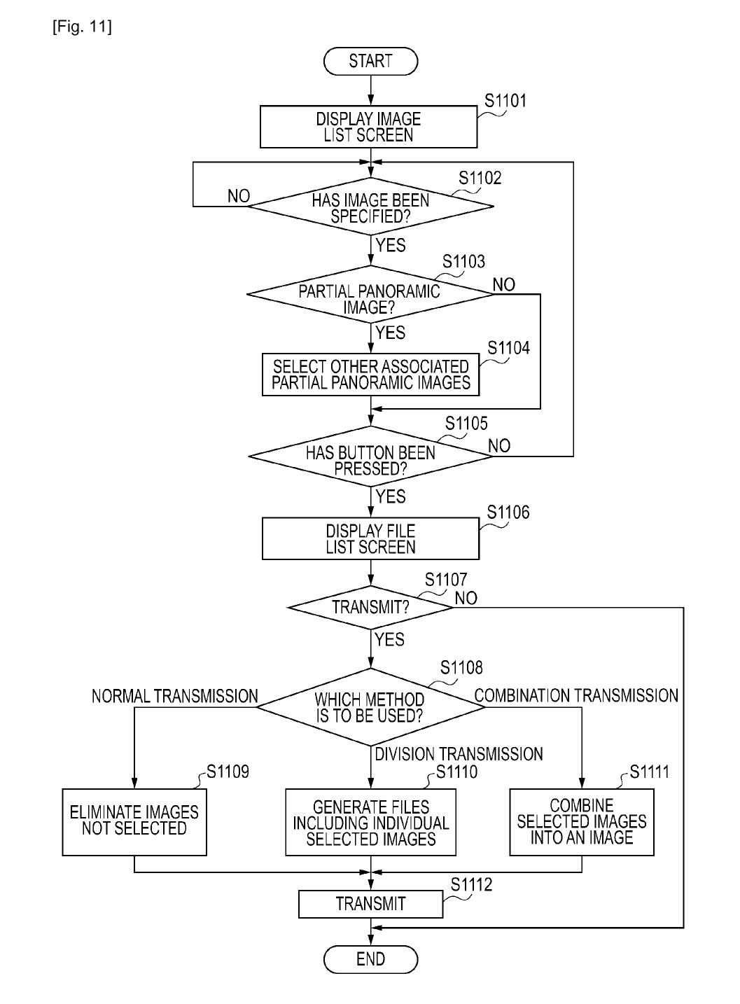

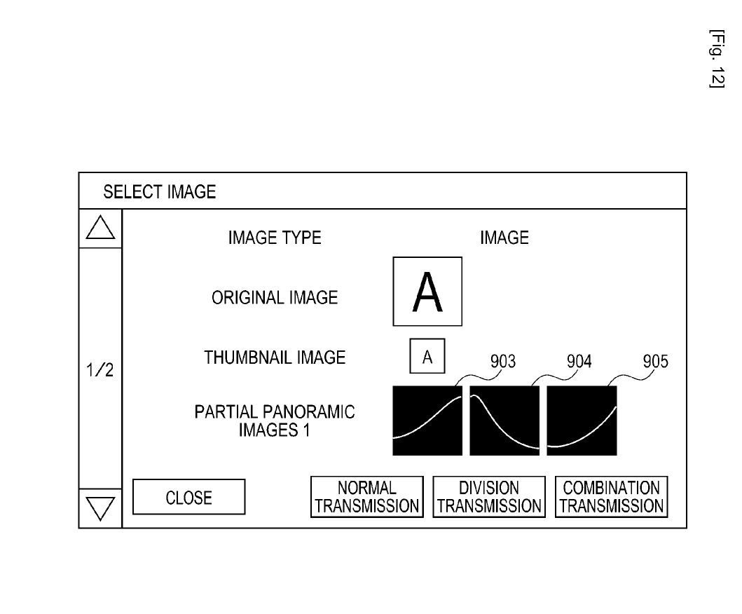

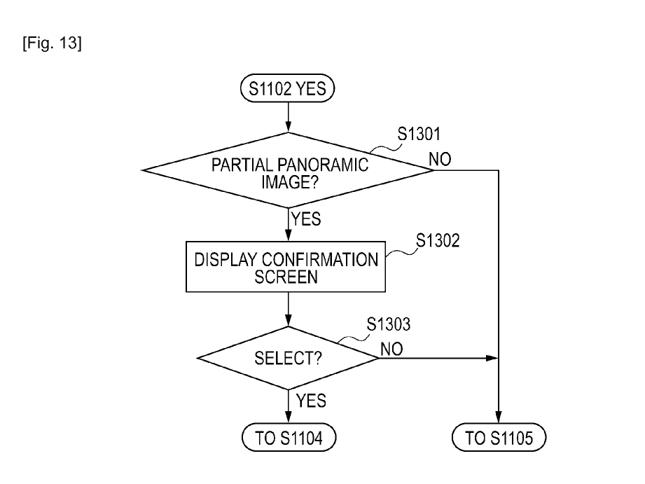

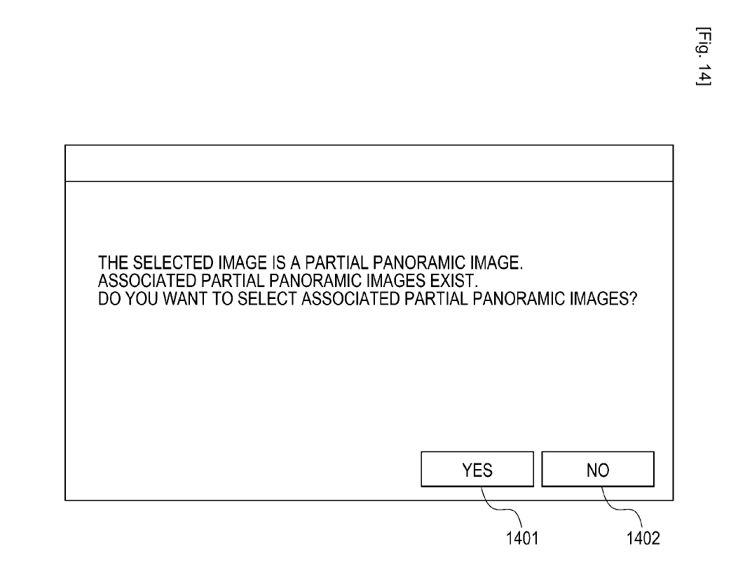

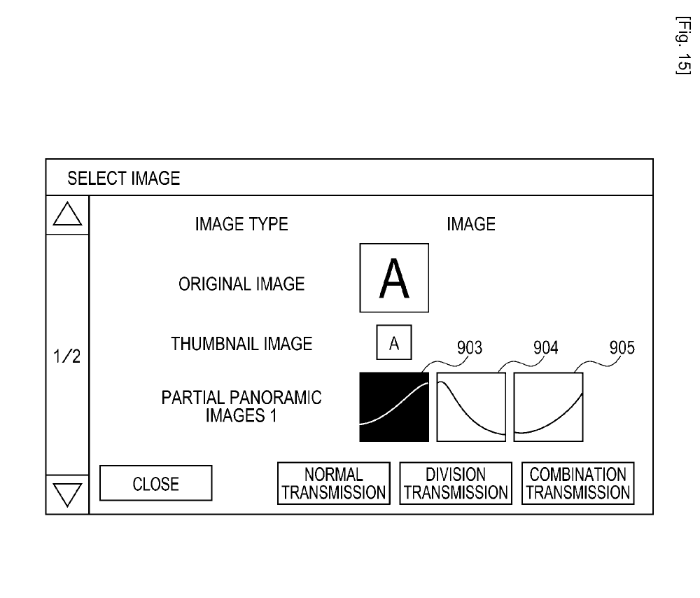

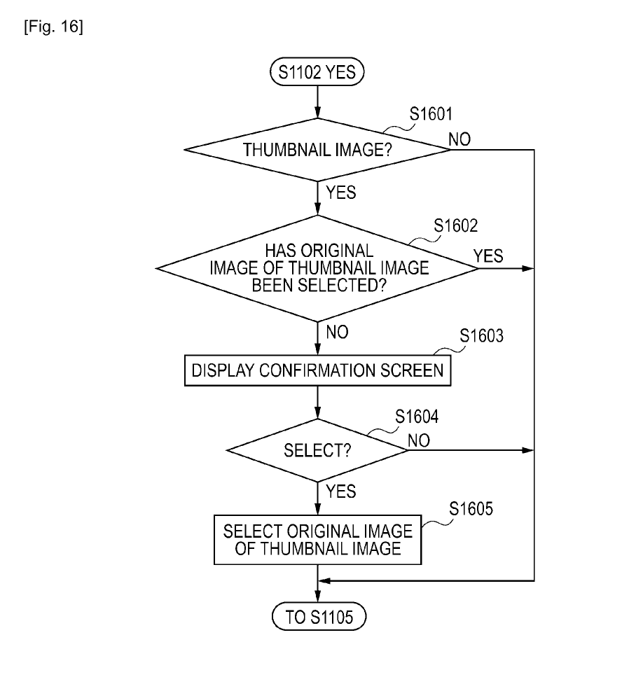

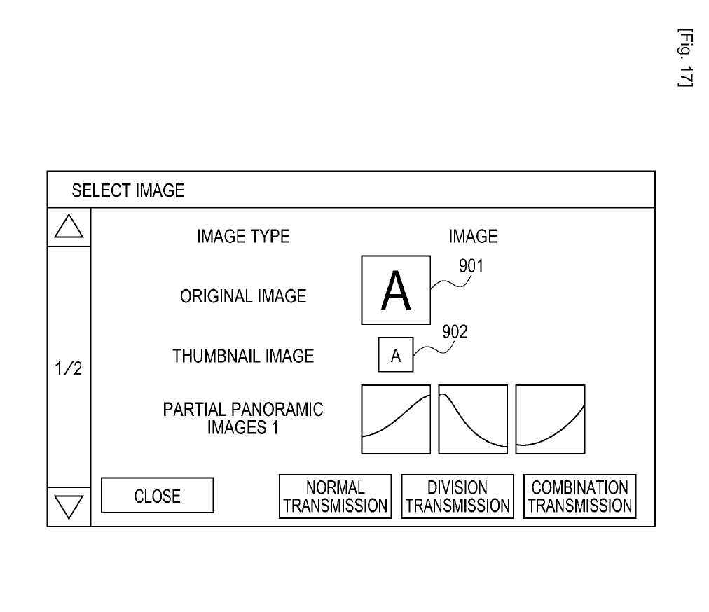

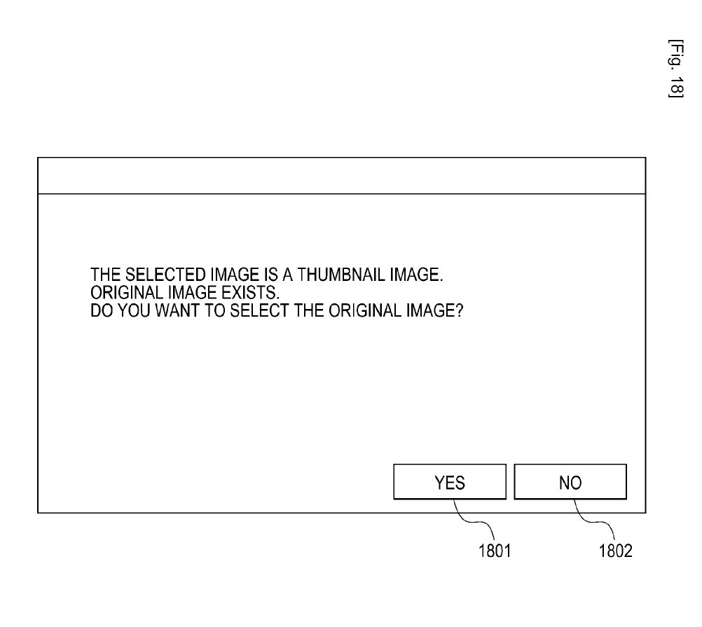

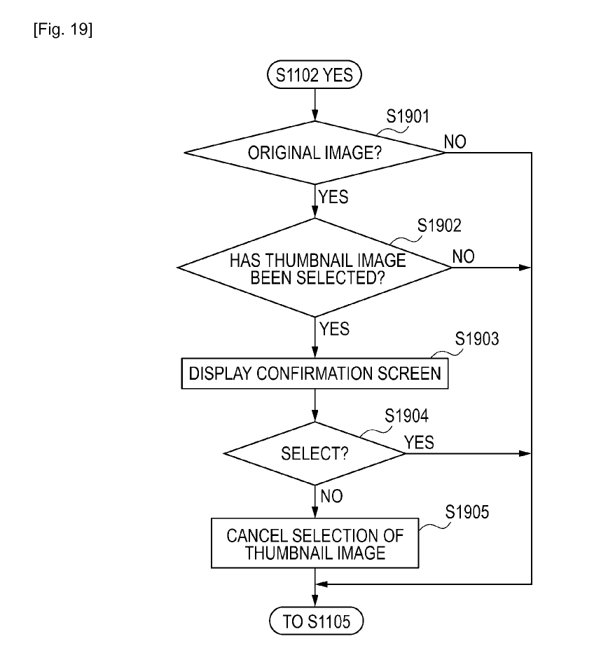

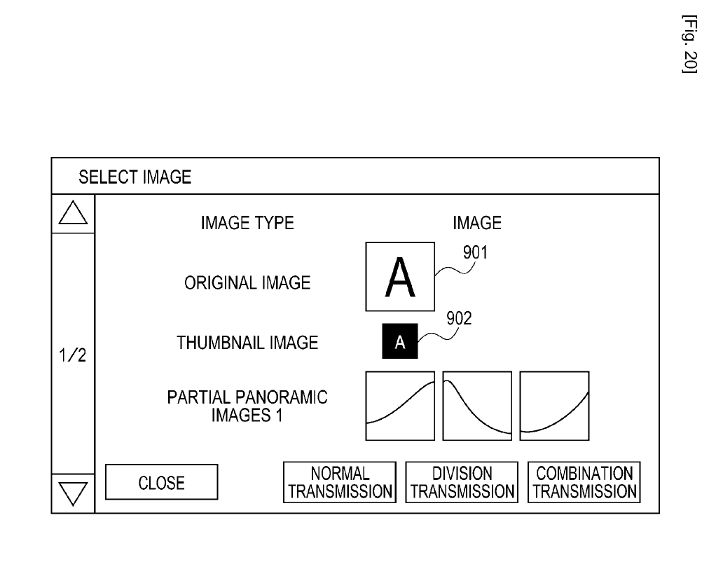

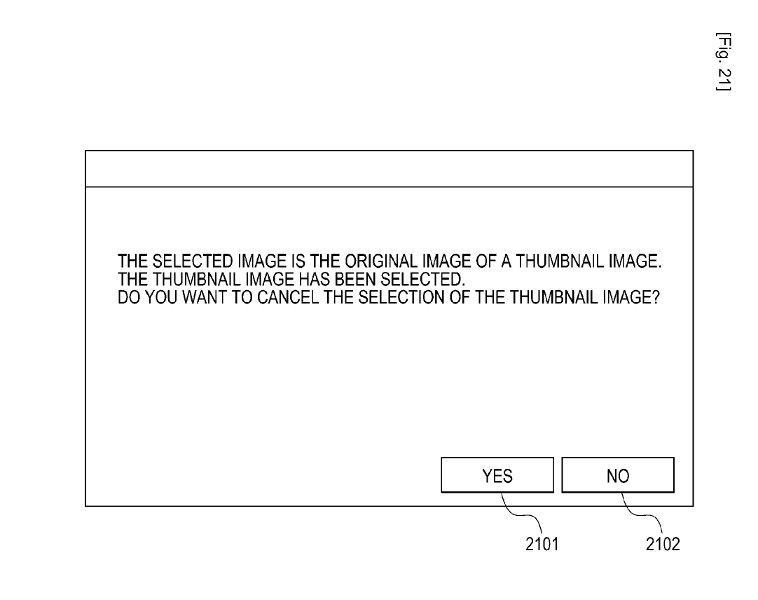

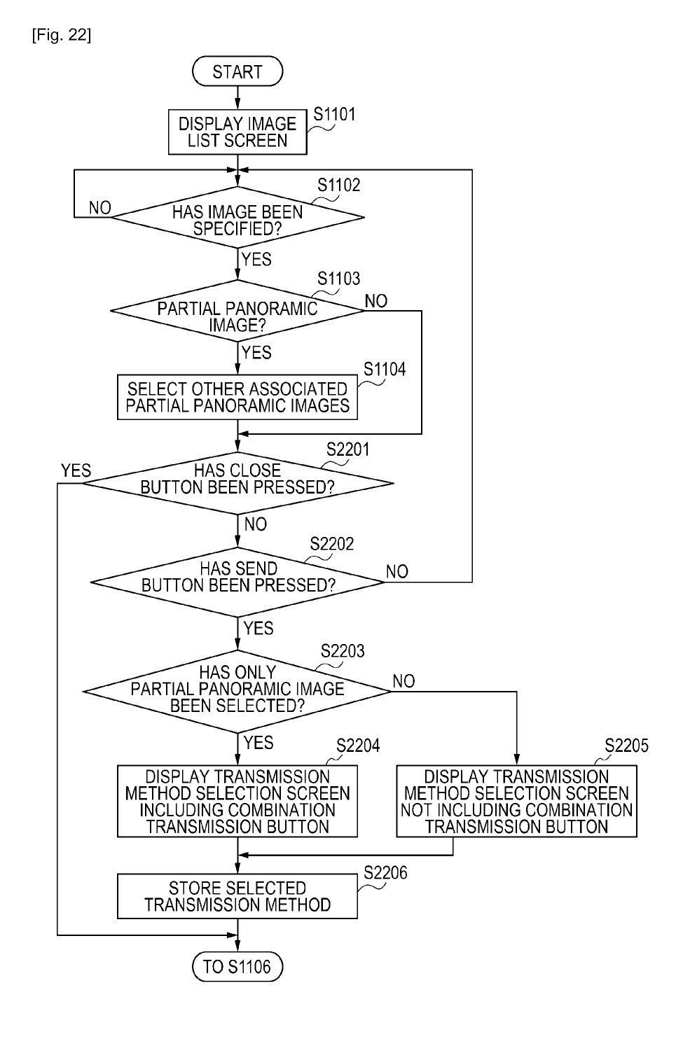

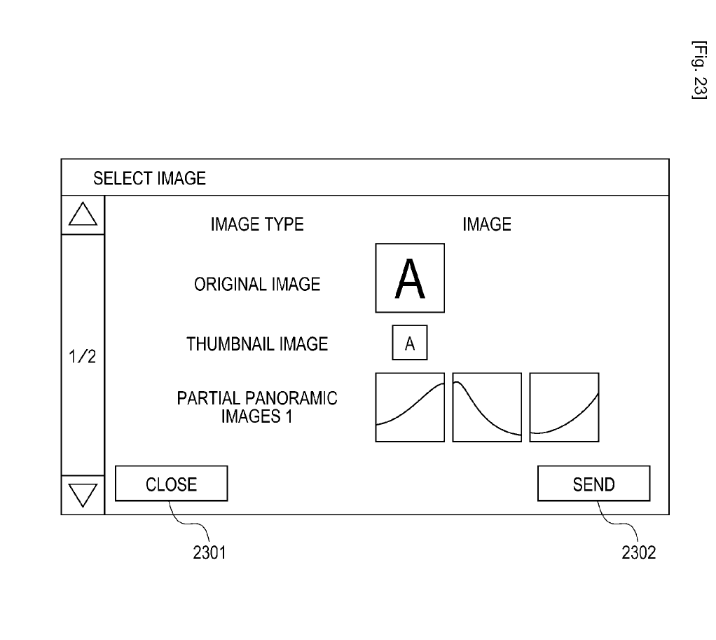

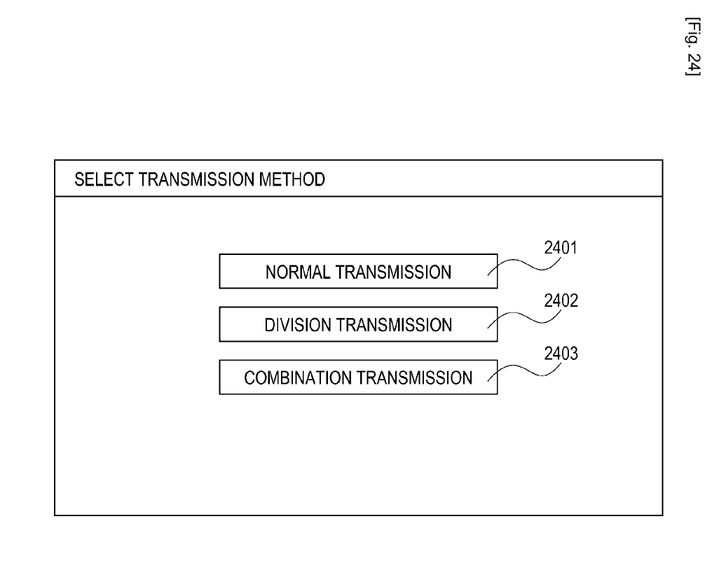

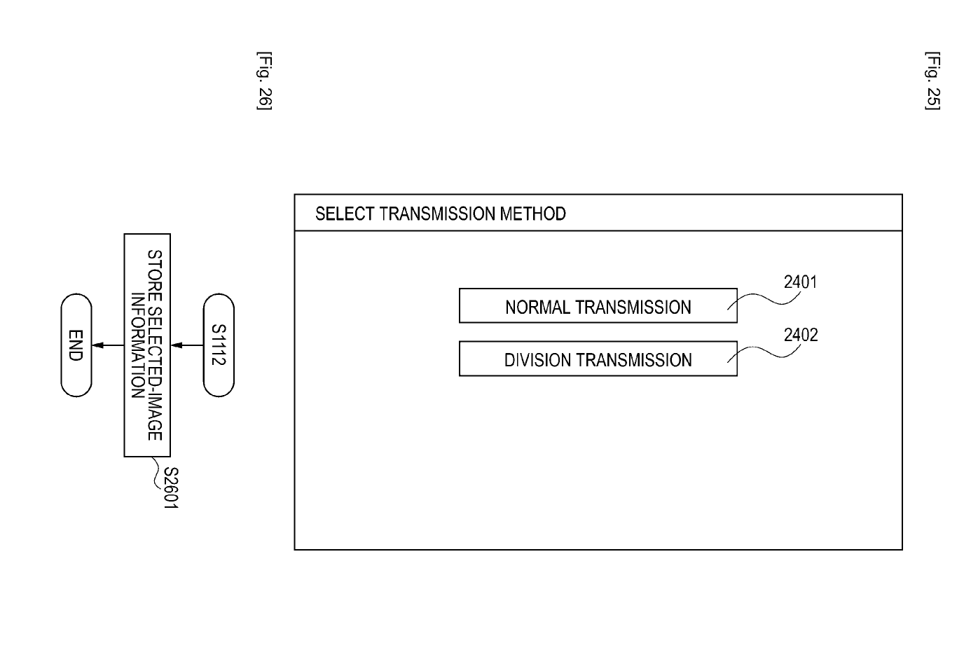

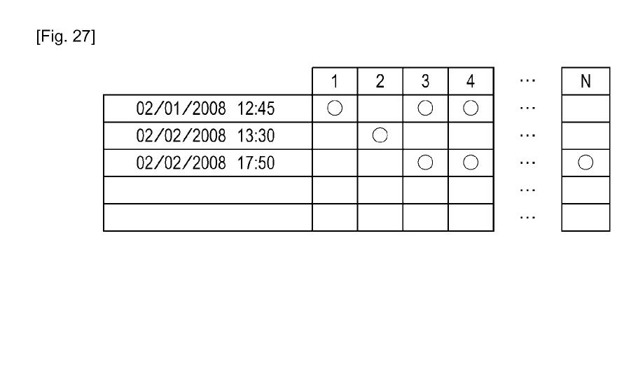

The accompanying drawings, which are incorporated in and constitute a part of the specification, illustrate embodiments of the invention and, together with the description, serve to explain the principle of the invention.

[FIG. 1]FIG. 1 is an illustration showing the entire network in an embodiment of the present invention.

[FIG. 2]FIG. 2 is a block diagram showing the configuration of an MFP according to an embodiment of the present invention.

[FIG. 3]FIG. 3 is an illustration showing a file list screen used in an embodiment of the present invention.

[FIG. 4]FIG. 4 is an illustration showing a destination specifying screen used in an embodiment of the present invention.

[FIG. 5]FIG. 5 is an illustration showing a file list screen used in an embodiment of the present invention.

[FIG. 6]FIG. 6 is an illustration showing the structure of a multi-image format used in an embodiment of the present invention.

[FIG. 7]FIG. 7 is an illustration showing the structure of an image header used in an embodiment of the present invention.

[FIG. 8]FIG. 8 is a flowchart for explaining a process for activating individual buttons in response to a specifying operation for specifying a file on a file list screen in an embodiment of the present invention.

[FIG. 9]FIG. 9 is an illustration showing an image list screen used in an embodiment of the present invention.

[FIG. 10]FIG. 10 is an illustration showing an image list screen used in an embodiment of the present invention.

[FIG. 11]FIG. 11 is a flowchart for explaining a process for selecting one or more images on an image list screen and performing an operation for transmitting the selected one or more images in an embodiment of the present invention.

[FIG. 12]FIG. 12 is an illustration showing an image list screen used in an embodiment of the present invention.

[FIG. 13]FIG. 13 is a flowchart for explaining a process for selecting one or more images on an image list screen and performing an operation for transmitting the selected one or more images in an embodiment of the present invention.

[FIG. 14]FIG. 14 is an illustration showing a confirmation screen used in an embodiment of the present invention.

[FIG. 15]FIG. 15 is an illustration showing an image list screen used in an embodiment of the present invention.

[FIG. 16]FIG. 16 is a flowchart for explaining a process for selecting one or more images on an image list screen and performing an operation for transmitting the selected one or more images in an embodiment of the present invention.

[FIG. 17]FIG. 17 is an illustration showing an image list screen used in an embodiment of the present invention.

[FIG. 18]FIG. 18 is an illustration showing a confirmation screen used in an embodiment of the present invention.

[FIG. 19]FIG. 19 is a flowchart for explaining a process for selecting one or more images on an image list screen and performing an operation for transmitting the selected one or more images in an embodiment of the present invention.

[FIG. 20]FIG. 20 is an illustration showing an image list screen used in an embodiment of the present invention.

[FIG. 21]FIG. 21 is an illustration showing a confirmation screen used in an embodiment of the present invention.

[FIG. 22]FIG. 22 is a flowchart for explaining a process for selecting one or more images on an image list screen and performing an operation for transmitting the selected one or more images in an embodiment of the present invention.

[FIG. 23]FIG. 23 is an illustration showing an image list screen used in an embodiment of the present invention.

[FIG. 24]FIG. 24 is an illustration showing a transmission method selection screen used in an embodiment of the present invention.

[FIG. 25]FIG. 25 is an illustration showing a transmission method selection screen used in an embodiment of the present invention.

[FIG. 26]FIG. 26 is a flowchart for explaining a process for selecting one or more images on an image list screen and performing an operation for transmitting the selected one or more images in an embodiment of the present invention.

[FIG. 27]FIG. 27 is an illustration showing a selected image information table used in an embodiment of the present invention.

### DESCRIPTION OF EMBODIMENTS

Embodiments of the present invention will be described with reference to the drawings. Note that the embodiments described below do not limit the invention according to the claims and that all the combinations of the features explained in the embodiments are not absolutely necessary to solve the problems of the present invention.

### First Embodiment

A first embodiment of the present invention will be described. In the first embodiment, an example in which in a case where at least one of a plurality of images included in a single file is specified by a user, in addition to the specified image, a different image of the same type as the specified image is selected will be explained. More specifically, an example in which in a case where a partial panoramic image is selected by a user, a different partial panoramic image associated with the specified partial panoramic image is automatically selected will be explained.

FIG. 1 is an illustration showing the entire network in the first embodiment. An MFP 100 including a scanner and a printer, which will be described later, and an MFP 110 having functions similar to those of the MFP 100 are provided on a local-area network (LAN) 150. The MFP 100 and the MFP 110 communicate with each other through the LAN 150 so that images can be transferred between the MFP 100 and the MFP 110.

In addition, a file server 120 that stores an image transmitted from the MFP 100 or transmits an image stored in the file server 120 to the MFP 100 in response to a request from the MFP 100 is provided on the LAN 150. Furthermore, the MFP 100 is also capable of performing electronic mail communication with the MFP 110 or other external apparatuses via an electronic mail server 130.

FIG. 2 is a block diagram showing the configuration of the MFP 100. A control unit 210 including a central processing unit (CPU) 211 controls the entire operation of the MFP 100. The CPU 211 reads a control program stored in a read-only memory (ROM) 212 and performs various control processes. A random-access memory (RAM) 213 is used as a main memory and a temporary storage area, such as a work area, of the CPU 211.

Images input to the MFP 100 are stored in a hard disk drive (HDD) 214. Images stored in the HDD 214 are displayed on a liquid crystal display part of an operation unit 220 and output to a printer 222, an external apparatus on the LAN 150, or a portable memory medium 221, in accordance with an operation from a user. The HDD 214 is also used for holding a file generated within the MFP 100.

An operation unit interface (I/F) 215 connects the operation unit 220 to the control unit 210. The operation unit 220 includes a liquid crystal display part having a touch panel function, a keyboard, and the like.

An external memory I/F 216 connects the portable memory medium 221 to the control unit 210. The portable memory medium 221 and the control unit 210 communicate with each other by using various wired or wireless communication methods such as universal serial bus (USB), and data such as images is transferred between the portable memory medium 221 and the control unit 210.

A printer I/F 217 connects the printer 222 to the control unit 210. An image to be printed by the printer 222 is transferred from the control unit 210 through the printer I/F 217 to the printer 222, and the printer 222 records the image in a recording medium.

A scanner I/F 218 connects a scanner 223 to the control unit 210. The scanner 223 reads an image on an original to generate image data, and inputs the image data through the scanner I/F 218 to the control unit 210. The scanner 223 is capable of generating a file in a format in which a single file includes a plurality of images, as described later.

A network I/F 219 connects the control unit 210 (MFP 100) to the LAN 150. The network I/F 219 transmits an image to an external apparatus on the LAN 150 and receives an image from the external apparatus on the LAN 150.

FIG. 3 is an illustration showing a file list screen displayed on the liquid crystal display part of the operation unit 220. A user performs an operation for specifying a file on this screen. A plurality of pieces of information respectively describing a plurality of files stored in the HDD 214 and the portable memory medium 221 are displayed on the file list screen. In a case where the number of files to be displayed exceeds the number of files that can be displayed on a single screen, a scroll key 301 is displayed. Information describing the total number of pages and the number of the page of the screen that is currently being displayed is provided in a region 302. For example, in the example shown in FIG. 3, the screen has five pages in total and the first page of the screen is currently being displayed.

Information on each file is displayed in a region 303. In the example shown in FIG. 3, information describing the name and stored date and time of each file is displayed. Since the liquid crystal display part has the touch panel function, the user is able to specify a desired file by touching a portion corresponding to the desired file in accordance with the indication in the region 303. In a case where a file is specified by the user, information on the file is selected and displayed in a highlighted manner. In the example shown in FIG. 3, a file “DEF” is selected by the user.

A destination specifying button 304 is pressed so that an output destination of an image included in a selected file is specified. In the following description, a method for transmitting an image included in a selected file to an external apparatus via the LAN 150 will be explained by way of example as a method for outputting an image included in a selected file. However, an image may be output by writing the image to the portable memory medium 221 connected to the MFP 100.

FIG. 4 is an illustration showing a destination specifying screen displayed on the liquid crystal display part of the operation unit 220. To transmit an image by using electronic mail, the user enters a mail address on the destination specifying screen. In addition, to transmit an image by using a file transmission protocol such as a service message block (SMB) protocol, the user enters information describing a host name and the directory of a transmission destination.

The destination information entered by the user is displayed in a region 401. After specifying a destination, when the user presses a set button 402, the destination specifying screen is closed and the file list screen shown in FIG. 3 is displayed again.

When the user selects one of the files displayed on the file list screen and presses a send button 305, an image included in the selected file is transmitted to the specified destination. In a case where an instruction to combine images has been issued, processing for combining images is performed in response to pressing of the send button 305 and then the combined image is transmitted.

An image selection button 306 is pressed so that an image to be output is selected from among a plurality of images included in a file selected by the user on the file list screen. The image selection button 306 becomes activated when a file selected by the user on the file list screen is a file of a predetermined format (that is, a multi-image format, which will be described later). In the example shown in FIG. 3, since the file “DEF”, which is not a file of the multi-image format, is specified, the image selection button 306 is grayed out so that selection cannot be performed.

FIG. 5 illustrates a file list screen similar to that shown in FIG. 3. In the example shown in FIG. 5, since a file “ABC”, which is a file of the multi-image format, is specified, the image selection button 306 is activated so that selection can be performed.

The multi-image format will now be explained.

FIG. 6 is an illustration showing the structure of the multi-image format. The address of an image header 602 on the first page, the size of the entire file, and information indicating that the file is in the multi-image format are stored in a file header 601.

Information on an image 603 on the first page is stored in the image header 602 on the first page. Information on an image 605 on the second page and information on an image 607 on the Nth page are stored in an image header 604 on the second page and an image header 606 on the Nth page, respectively.

Types of images stored in individual pages include, for example, thumbnail images, partial panoramic images, and multi-viewpoint images, as well as normal images. A thumbnail image is obtained by reducing the resolution of the original image so that the same image as the original image can be displayed. The thumbnail image and the original image of the thumbnail image make a pair.

Partial panoramic images are partial images obtained by taking shots in a wide area. The partial panoramic images are combined to form a single panoramic image.

Multi-viewpoint images are obtained by taking shots of an object from a plurality of angles, such as from the upper side, lower side, left side, and right side. Unlike partial panoramic images, multi-viewpoint images are not necessarily consecutive. However, multi-viewpoint images obtained by capturing images of the same object are associated with each other.

In addition to the types of images mentioned above, a file of the multi-image format may include various other types of images, such as burst-shot images continuously captured at predetermined short intervals and images for stereoscopic viewing captured so that an object can be reproduced in a stereoscopic manner.

Here, individual images included in a file of the multi-image format are assumed as images in a general-purpose format, such as Joint Photographic Experts Group (JPEG) images. Thus, in a case where a file of the multi-image format is input to an MFP or a personal computer (PC) not supporting the multi-image format, an image only on the first page can be displayed using general-purpose JPEG viewer software.

FIG. 7 is an illustration showing the structure of the image header 602 shown in FIG. 6. A representative image flag 701 is turned on when the image 603 is a representative image. A representative image is specified in advance as a representative of a file. Only one of a plurality of images included in a single file is specified as a representative image.

An original image flag 702 is turned on when the image 603 is the original image of a thumbnail image. A thumbnail image flag 703 is turned on when the image 603 is a thumbnail image. That is, in a case where the resolution of a certain image is reduced and thus the image 603 is generated as a thumbnail image, the thumbnail image flag 703 of the image header 602 of the image 603 is turned on. In a case where the resolution of the image 603 is reduced and thus a different image is generated as a thumbnail image, the original image flag 702 of the image header 602 of the image 603 is turned on.

In a case where the image 603 is a thumbnail image or the original image of a thumbnail image, information on a different image associated with the image 603 is stored as thumbnail-associated image information 704. That is, in a case where the image 603 is a thumbnail image, information stored as the thumbnail-associated image information 704 describes the original image corresponding to the image 603. In addition, in a case where the image 603 is the original image, information stored as the thumbnail-associated image information 704 describes a thumbnail image corresponding to the image 603. Information on the resolution of the image 603 is stored as resolution 705.

A panoramic image flag 706 is turned on when the image 603 is a partial panoramic image. In a case where the image 603 is a partial panoramic image, information on a different partial panoramic image associated with the image 603 is stored as panorama-associated image information 707. In a case where a plurality of partial panoramic images associated with the image 603 exist, a plurality of pieces of information on the individual partial panoramic images are stored as the panorama-associated image information 707. Information on the position of the image 603 in a panoramic image to be reproduced by combining a plurality of associated partial panoramic images is stored as positional information 708. That is, the original image can be reproduced from a plurality of partial panoramic images by using information stored as the positional information 708.

A multi-viewpoint image flag 709 is turned on when the image 603 is a multi-viewpoint image. In a case where the image 603 is a multi-viewpoint image, information on a different multi-viewpoint image associated with the image 603 is stored as multi-viewpoint-associated image information 710. In a case where a plurality of multi-viewpoint images associated with the image 603 exist, a plurality of pieces of information on the individual multi-viewpoint images are stored as the multi-viewpoint-associated image information 710. Information describing at which angle a plurality of associated multi-viewpoint images are obtained by capturing images of an object is stored as positional information 711.

Information fields other than the fields for the information 701 to 711 can be added to the image header 602 in an appropriate manner in accordance with the types of images that can be included in a multi-image format.

FIG. 8 is a flowchart for explaining a process for activating individual buttons in response to a specifying operation for specifying a file on the file list screen. Individual processing operations shown in the flowchart of FIG. 8 are implemented when the CPU 211 of the MFP 100 executes a control program.

In step S801, the file list screen is displayed on the liquid crystal display part of the operation unit 220. In step S802, it is determined whether or not at least one file has been specified by a user. In a case where it is determined that at least one file has been specified by the user (YES in step S802), the process proceeds to step S803. Meanwhile, in a case where it is determined that no file has been specified by the user (NO in step S802), the process is terminated.

In step S803, it is determined whether or not the file specified by the user is in a multi-image format. The determination in step S803 is performed in accordance with information stored in the file header 601 shown in FIG. 6. In a case where it is determined that the file specified by the user is in the multi-image format (YES in step S803), the process proceeds to step S804. Meanwhile, in a case where it is determined that the file specified by the user is not in the multi-image format (NO in step S803), the process proceeds to step S805.

In step S804, the image selection button 306 is activated so that selection can be performed. In steps S805 and S806, the destination specifying button 304 and the send button 305 are activated so that selection can be performed. Then, the process is completed.

FIG. 9 is an illustration showing an image list screen displayed on the liquid crystal display part of the operation unit 220 in a case where the image selection button 306 is pressed while the file “ABC” is selected. The user performs an operation for specifying an image on this screen. Information describing a plurality of images included in the file “ABC” is displayed on the image list screen so that the user can identify the types of the individual images.

In the example shown in FIG. 9, the file “ABC” includes an image 901 and an image 902 generated by reducing the resolution of the image 901. The image 901 is the original image of a thumbnail image. The image 902 is a thumbnail image.

In addition, the file “ABC” further includes images 903 to 905, which are partial panoramic images. The images 903 to 905 are displayed in a horizontal line so that the user can recognize that the images 903 to 905 are partial panoramic images associated with each other (constituting a single panoramic image).

FIG. 10 illustrates an image list screen displayed when the user scrolls the screen shown in FIG. 9. Information describing other images included in the file “ABC” is displayed on the image list screen shown in FIG. 10. Images 1001 to 1003 are partial panoramic images associated with each other. The images 1001 to 1003 are not associated with the images 903 to 905. The images 1001 to 1003 constitute another panoramic image.

Images 1004 to 1006 are multi-viewpoint images. Similarly to partial panoramic images, the images 1004 to 1006 are displayed in a horizontal line so that the user can recognize that the images 1004 to 1006 are multi-viewpoint images associated with each other.

The user is able to specify one or more desired images by touching portions corresponding to the desired images on the image list screen. In a case where an image is specified by the user, information on the image is selected and displayed in a highlighted manner.

The selected one or more images are output by using one of a first output method, a second output method, and a third output method, as described later. The user is able to specify a desired output method by selecting one of a normal transmission button 907, a division transmission button 908, and a combination transmission button 909.

The first output method is used in a case where the normal transmission button 907 is pressed. In the first output method, one or more images included in a single file are selected, and the selected one or more images are transmitted as a single file. That is, in a case where the normal transmission button 907 is pressed, images that are not selected are eliminated, and a file in a multi-image format only including the selected images is transmitted.

The second output method is used in a case where the division transmission button 908 is pressed. The division transmission button 908 is pressed in a case where a plurality of images included in a single file are selected and transmitted as individual files. That is, in a case where the division transmission button 908 is pressed, files whose number is equal to the number of selected images are generated and transmitted. In this example, a file of a multi-image format including a single image is generated. However, instead of a file of the multi-image format, a general-purpose JPEG image file may be used.

The third output method is used in a case where the combination transmission button 909 is pressed. The combination transmission button 909 is pressed in a case where a plurality of images included in a single file are selected and combined into an image and the combined image is transmitted. That is, in a case where the combination transmission button 909 is pressed, the selected images are combined to form an image and a file including the generated image is transmitted. In this example, a file of a multi-image format including a single combined image is generated. However, instead of a file of the multi-image format, the combined single image may be included in a general-purpose JPEG image file.

When one of the buttons 907 to 909 is pressed, information describing one or more images selected by the user on the image list screen and information describing which one of the buttons 907 to 909 is pressed are temporarily stored in a memory of the MFP 100. Then, the file list screen is displayed again. In a case where a close button 906 is pressed, all the selections made by the user on the image list screen are canceled, and the file list screen is displayed again.

FIG. 11 is a flowchart for explaining a process for selecting one or more images on the image list screen and performing an operation for transmitting the selected one or more images. Individual processing operations shown in the flowchart of FIG. 11 are implemented when the CPU 211 of the MFP 100 executes a control program.

In step S1101, the image list screen is displayed on the liquid crystal display part of the operation unit 220. In step S1102, it is determined whether or not at least one image has been specified by a user. In a case where it is determined that at least one image has been specified by the user (YES in step S1102), the process proceeds to step S1103. Meanwhile, in a case where it is determined that no image has been specified by the user (NO in step S1102), the processing of step S1102 is repeated until at least one image has been specified by the user.

In step S1103, it is determined whether or not the specified image is a partial panoramic image. In a case where it is determined that the specified image is a partial panoramic image (YES in step S1103), the process proceeds to step S1104. Meanwhile, in a case where it is determined that the specified image is not a partial panoramic image (NO in step S1103), the process proceeds to step S1105.

In step S1104, a different partial panoramic image associated with the specified image is automatically selected. The processing of step S1104 will be explained with reference to FIG. 12.

FIG. 12 illustrates an image list screen similar to that shown in FIG. 9. In a case where the image 903 has been specified by the user, the processing of steps S1102 to S1104 is performed. As a result, the images 903 to 905 are selected, as shown in FIG. 12. As described above, in a case where a partial panoramic image has been specified by the user, all the partial panoramic images associated with the specified partial panoramic image are automatically selected. Thus, a situation in which only some of a plurality of partial panoramic images constituting a single panoramic image are output can be prevented.

Referring back to FIG. 11, in step S1105, it is determined whether or not one of the buttons 906 to 909 has been pressed. In a case where it is determined that one of the buttons 906 to 909 has been pressed (YES in step S1105), the process proceeds to step S1106. Meanwhile, in a case where it is determined that none of the buttons 906 to 909 has been pressed (NO in step S1105), the process returns to step S1102.

In step S1106, the file list screen is displayed on the liquid crystal display part of the operation unit 220. In step S1107, it is determined whether or not the send button 305 has been pressed. In a case where it is determined that the send button 305 has been pressed (YES in step S1107), the process proceeds to step S1108. Meanwhile, in a case where it is determined that the send button 305 has not been pressed (NO in step S1107), the process is terminated.

In step S1108, it is determined which one of a normal transmission method, a division transmission method, and a combination transmission method has been selected as a method for outputting one or more images included in the file selected on the file list screen. In a case where the selected file is not in a multi-image format, processing of steps S1108 to S1111 is skipped and the selected file is transmitted without being subjected to any processing.

The determination in step S1108 is performed in accordance with information describing which one of the buttons 907 to 909 has been pressed. The information describing which one of the buttons 907 to 909 has been pressed is temporarily stored when the image list screen is closed in step S1105. In a case where it is determined that the normal transmission button 907 has been pressed, the process proceeds to step S1109. In step S1109, images that are not selected on the image list screen are eliminated, and a file in a multi-image format only including the selected one or more images is generated.

In a case where it is determined that the division transmission button 908 has been pressed, the process proceeds to step S1110. In step S1110, a plurality of files respectively including the selected images are generated. In a case where it is determined that the combination transmission button 909 has been pressed, the process proceeds to step S1111. In step S1111, the selected images are combined into an image, and a file including the combined image is generated.

In step S1112, the file (or the files) generated in any one of steps S1109 to S1111 is transmitted to a specified destination.

As described above, in the first embodiment, in a case where at least one of a plurality of images included in a single file has been specified by a user, in addition to the specified image, a different image of the same type as the specified image is selected. Consequently, it is not necessary for the user to specify a large number of images to be selected one by one. In addition, a situation in which the user forgets to select an image to be selected can be prevented.

In the first embodiment, an example in which in a case where a partial panoramic image has been selected by a user, a different partial panoramic image associated with the specified partial panoramic image is automatically selected, has been explained. However, similar processing may be performed in a case where images of other types, such as multi-viewpoint images and burst-shot images, have been specified.

### Second Embodiment

A second embodiment of the present invention will next be explained. In the first embodiment, an example in which in a case where an image on the image list screen has been specified by a user, a different image associated with the specified image is automatically selected, has been described. In the second embodiment, a case where a unit configured to allow a user to confirm whether or not to select an image associated with a specified image is provided, will be described. Since the other features of the configuration in the second embodiment are similar to those in the first embodiment, those similar features will not be explained here.

### First Processing Example in Second Embodiment

As a first processing example, an example in which when a partial panoramic image on the image list screen is selected by a user, the user confirms whether or not to select a different partial panoramic image associated with the specified image will be explained.

FIG. 13 is a flowchart corresponding to the flowchart shown in FIG. 11. Processing operations shown in the flowchart of FIG. 13 are performed when the CPU 211 of the MFP 100 executes a control program.

In a case where it is determined that at least one image has been specified by the user (YES in step S1102 in the flowchart of FIG. 11), the process proceeds to step S1301.

In step S1301, it is determined whether or not the specified image is a partial panoramic image. In a case where it is determined that the specified image is a partial panoramic image (YES in step S1301), the process proceeds to step S1302. Meanwhile, in a case where it is determined that the specified image is not a partial panoramic image (NO in step S1301), the process proceeds to step S1105 in the flowchart of FIG. 11. In step S1302, a confirmation screen for allowing the user to confirm whether or not to select a different partial panoramic image associated with the specified image is displayed on the liquid crystal display part of the operation unit 220.

FIG. 14 illustrates the confirmation screen displayed in step S1302. As shown in FIG. 14, a message indicating that the image specified by the user is a partial panoramic image and a message indicating that a different partial panoramic image associated with the specified image exists are displayed on the confirmation screen. The user is queried as to whether or not to select a different partial panoramic image associated with the specified image. The user responds to the query by pressing a YES button 1401 or a NO button 1402.

When the YES button 1401 is pressed, the associated partial panoramic images are selected, as shown in FIG. 9. Meanwhile, when the NO button 1402 is pressed, the image specified by the user is selected and the associated partial panoramic images are not selected, as shown in FIG. 15.

As described above, when a partial panoramic image is specified by a user, the user confirms whether or not to select a different partial panoramic image associated with the specified image. Hence, compared with a case where a plurality of partial panoramic images are specified one by one, the time and effort required for the user can be reduced. In addition, in a case where a user desires to select only some of a plurality of partial panoramic images constituting a single panoramic image, only the images specified by the user can be selected.

### Second Processing Example in Second Embodiment

As a second processing example, an example in which when a thumbnail image on the image list screen is specified by a user and the original image corresponding to the thumbnail image is not selected by the user, the user confirms whether or not to select the original image will be explained.

FIG. 16 is a flowchart corresponding to the flowchart shown in FIG. 11. Processing operations shown in the flowchart of FIG. 16 are performed when the CPU 211 of the MFP 100 executes a control program.

In a case where it is determined that at least one image has been specified by the user (YES in step S1102 in the flowchart of FIG. 11), the process proceeds to step S1601.

In step S1601, it is determined whether or not the specified image is a thumbnail image. In a case where it is determined that the specified image is a thumbnail image (YES in step S1601), the process proceeds to step S1602. Meanwhile, in a case where it is determined that the specified image is not a thumbnail image (NO in step S1601), the process proceeds to step S1105 in the flowchart of FIG. 11.

In step S1602, it is determined whether or not the original image corresponding to the specified thumbnail image has been selected. In a case where it is determined that the original image corresponding to the specified thumbnail image has been selected (YES in step S1602), the process proceeds to step S1105 in the flowchart of FIG. 11. Meanwhile, in a case where it is determined that the original image corresponding to the specified thumbnail image has not been selected (NO in step S1602), the process proceeds to step S1603.

That is, in a case where none of images 901 and 902 have been selected, as shown in FIG. 17, when the user specifies the image 902, which is a thumbnail image, the process proceeds to step S1603.

In step S1603, a confirmation screen for allowing the user to confirm whether or not to select the original image corresponding to the specified thumbnail image is displayed on the liquid crystal display part of the operation unit 220.

FIG. 18 illustrates the confirmation screen displayed in step S1603. As shown in FIG. 18, a message indicating that the image specified by the user is a thumbnail image and a message indicating that the original image corresponding to the specified thumbnail image exists are displayed on the confirmation screen. The user is queried as to whether or not to select the original image corresponding to the specified image. The user responds to the query by pressing a YES button 1801 or a NO button 1802.

When the YES button 1801 is pressed, the original image is selected. Here, selection of the thumbnail image specified by the user (the image 902 shown in FIG. 17) may be automatically canceled. Meanwhile, when the NO button 1802 is pressed, only the thumbnail image specified by the user is selected and the original image corresponding to the specified thumbnail image is not selected.

As described above, when a thumbnail image is specified by a user and the original image corresponding to the specified thumbnail image is not selected by the user, the user confirms whether or not to select the original image. Hence, the advantages described below can be expected. That is, even in a case where the user does not realize that the image specified by the user is a thumbnail image or the user does not know that the original image corresponding to the thumbnail image exists, such confirmation allows the user to select an image of a higher resolution.

### Third Processing Example in Second Embodiment

As a third processing example, an example in which when the original image of a thumbnail image on the image list screen is specified by a user and the thumbnail image corresponding to the original image has been selected by the user, the user confirms whether or not to cancel the selection of the thumbnail image will be explained.

FIG. 19 is a flowchart corresponding to the flowchart shown in FIG. 11. Processing operations shown in the flowchart of FIG. 19 are performed when the CPU 211 of the MFP 100 executes a control program.

In a case where it is determined that at least one image has been specified by the user (YES in step S1102 in the flowchart of FIG. 11), the process proceeds to step S1901.

In step S1901, it is determined whether or not the specified image is the original image of a thumbnail image. In a case where it is determined that the specified image is the original image of a thumbnail image (YES in step S1901), the process proceeds to step S1902. Meanwhile, in a case where it is determined that the specified image is not the original image of a thumbnail image (NO in step S1901), the process proceeds to step S1105 in the flowchart of FIG. 11.

In step S1902, it is determined whether or not the thumbnail image corresponding to the specified image has been selected. In a case where it is determined that the thumbnail image corresponding to the specified image has been selected (YES in step S1902), the process proceeds to step S1903. Meanwhile, in a case where it is determined that the thumbnail image corresponding to the specified image has not been selected (NO in step S1902), the process proceeds to step S1105 of FIG. 11.

That is, in a case where the image 902 has been selected, as shown in FIG. 20, when the user specifies the image 901, which is the original image of a thumbnail image, the process proceeds to step S1903.

In step S1903, a confirmation screen for allowing the user to confirm whether or not to select the thumbnail image corresponding to the specified image is displayed on the liquid crystal display part of the operation unit 220.

FIG. 21 illustrates the confirmation screen displayed in step S1903. As shown in FIG. 21, a message indicating that the image specified by the user is the original image of a thumbnail image and a message indicating that the thumbnail image corresponding to the specified image has been selected are displayed on the confirmation screen. The user is queried as to whether or not to cancel the selection of the thumbnail image corresponding to the specified image. The user responds to the query by pressing a YES button 2101 or a NO button 2102.

When the YES button 2101 is pressed, the selection of the thumbnail image is canceled. Meanwhile, when the NO button 2102 is pressed, the original image newly specified by the user is selected while the thumbnail image is selected.

As described above, when the original image of a thumbnail image is specified by a user and the thumbnail image corresponding to the specified image has been selected by the user, the user confirms whether or not to cancel the selection of the thumbnail image. Hence, the advantages described below can be expected. That is, in a case where the user misunderstands that the original image of a thumbnail image is not associated with the thumbnail image and selects both the original image and the thumbnail image, the user is able to become aware that the original image and the thumbnail image have the same contents. Hence, when the user determines that the thumbnail image is not to be output, unnecessary data output can be suppressed.

### Third Embodiment

A third embodiment of the present invention will next be explained. In the first embodiment, in a case where an image on the image list screen is selected, a method for transmitting the selected image is specified by pressing one of the buttons 907 to 909. In the third embodiment, a transmission method selection screen is displayed independently of the image list screen, so that the user can select a transmission method on the transmission method selection screen. Since the other features of the configuration in the third embodiment are similar to those in the first embodiment, those similar features will not be explained here.

FIG. 22 is a flowchart corresponding to the flowchart shown in FIG. 11. Processing operations shown in the flowchart of FIG. 22 are performed when the CPU 211 of the MFP 100 executes a control program.

In step S1101, the image list screen is displayed on the liquid crystal display part of the operation unit 220.

FIG. 23 illustrates an image list screen used in the third embodiment. As is clear from comparison with the image list screen shown in FIG. 9, instead of the buttons 907 to 909 shown in FIG. 9, a send button 2302 is displayed on the image list screen shown in FIG. 23.

In step S1102, it is determined whether or not at least one image has been specified by a user. In a case where it is determined that at least one image has been specified by the user (YES in step S1102), the process proceeds to step S1103. Meanwhile, in a case where it is determined that no image has been specified by the user (NO in step S1102), the processing of step S1102 is repeated until at least one image has been specified by the user.

In step S1103, it is determined whether or not the specified image is a partial panoramic image. In a case where it is determined that the specified image is a partial panoramic image (YES in step S1103), the process proceeds to step S1104. Meanwhile, in a case where it is determined that the specified image is not a partial panoramic image (NO in step S1103), the process proceeds to step S2201. In step S1104, a different partial panoramic image associated with the specified image is automatically selected.

In step S2201, it is determined whether or not a close button 2301 has been pressed. In a case where it is determined that the close button 2301 has been pressed (YES in step S2201), the process proceeds to step S1106 in the flowchart of FIG. 11. Meanwhile, in a case where it is determined that the close button 2301 has not been pressed (NO in step S2201), the process proceeds to step S2202.

In step S2202, it is determined whether or not the send button 2302 has been pressed. In a case where it is determined that the send button 2302 has been pressed (YES in step S2202), the process proceeds to step S2203. Meanwhile, in a case where it is determined that the send button 2302 has not been pressed (NO in step S2202), the process returns to step S1102.

In step S2203, it is determined whether or not the one or more images selected on the image list screen include only partial panoramic images constituting a single panoramic image. In a case where it is determined that the images selected on the image list screen include only partial panoramic images constituting a single panoramic image (YES in step S2203), the process proceeds to step S2204. Meanwhile, in a case where it is determined that the images selected on the image list screen include partial panoramic images constituting different panoramic images (NO in step S2203), the process proceeds to step S2205.

In steps S2204 and S2205, transmission method selection screens shown in FIGS. 24 and 25 are displayed.

FIGS. 24 and 25 show transmission method selection screens displayed when the send button 2302 is pressed. Here, the details of a transmission method selection screen to be displayed differ depending on which type of image has been selected on the image list screen.

FIG. 24 illustrates a screen displayed in a case where images selected on the image list screen include only a plurality of partial panoramic images constituting a single panoramic image. In a case where only a plurality of partial panoramic images constituting a single panoramic image are selected, a user might want to combine these partial panoramic images into a single panoramic image and transmit the combined panoramic image. Thus, a combination transmission button 2403 used for issuing an instruction to perform combination transmission as a transmission method is displayed.

FIG. 25 illustrates a screen displayed in a case where images selected on the image list screen include a plurality of partial panoramic images constituting different panoramic images. In a case where a plurality of partial panoramic images constituting different panoramic images are selected, a user is unlikely to combine these partial panoramic images into a single panoramic image and transmit the combined panoramic image. Thus, in order to avoid the user from issuing an instruction to perform combination transmission, the combination transmission button 2403 is not displayed.

When one of the transmission methods on the transmission method selection screen displayed in FIG. 24 or 25 is selected, the selected transmission method is temporarily stored in the memory of the MFP 100 in step S2206. Then, the process proceeds to step S1106 in the flowchart of FIG. 11.

As described above, an output method determination process for determining a selectable output method in accordance with which type of image has been selected on the image list screen is performed, and different details are displayed on the transmission method selection screens. Hence, selection of an inappropriate transmission method by a user can be avoided.

In a case where only one image is selected on the image list screen, the process may proceed to step S1106 without displaying the transmission method selection screen shown in FIG. 24 or FIG. 25. This is because in a case where only one image is selected, only a file including the image can be transmitted and other transmission methods cannot be selected.

In addition, in a case where images selected on the image list screen include only a plurality of partial panoramic images constituting a single panoramic image, combination transmission may be automatically selected without displaying the transmission method selection screen and allowing the user to select a transmission method.

In addition, although a case where a different selectable transmission method is set in accordance with whether or not images selected on the image list screen include only a plurality of partial panoramic images constituting a single panoramic image has been described above, a selectable transmission method may be set in accordance with other conditions.

### Fourth Embodiment

A fourth embodiment of the present invention will next be explained. In the fourth embodiment, a case where a unit configured to, after one or more images are selected from among a plurality of images included in a single file and the selected one or more images are output, store information describing the output one or more images is provided, will be explained. Since the other features of the configuration in the fourth embodiment are similar to those in the first embodiment, those similar features will not be explained here.

### First Processing Example in Fourth Embodiment

As a first processing example, an example in which after a selected image is output, information describing the selected image is stored in association with the original file will be explained.

FIG. 26 is a flowchart corresponding to the flowchart shown in FIG. 11. Processing operations shown in the flowchart of FIG. 26 are performed when the CPU 211 of the MFP 100 executes a control program.

After the selected image is output in step S1112 of FIG. 11, the process proceeds to step S2601. In step S2601, information describing the selected image is stored in the memory of the MFP 100. Then, the process is completed.

FIG. 27 illustrates a selected-image information table provided in the memory inside the MFP 100. The table shown in FIG. 27 is stored in association with individual files stored in the HDD 214 or the portable memory medium 221.

The table shown in FIG. 27 shows that images on the first, third, and forth pages were selected and output at 12:45 on Feb. 1, 2008. In addition, the table shows that only an image on the second page was selected and output at 13:30 on Feb. 2, 2008.

As described above, information describing a selected image is stored in association with the original file. Thus, in a case where a user wants to output the image that was previously selected and output, by referring to the selected-image information table, the user does not need to perform an operation for selecting the image.

When information describing an output method that was used for outputting a selected image is also stored in the selected-image information table, improved user-friendliness can be achieved.

### Second Processing Example in Fourth Embodiment

Next, a second processing example will be explained. In the first processing example, an example in which information describing a selected image is stored in association with the original file has been explained. In the second processing example, a file that has been actually output is stored in the HDD 214 independently of the original file. Thus, in a case where a user wants to output a file that was previously output, a time required for a file generation process can be reduced.

In the first to fourth embodiments described above, examples in which a user specifies a desired image on an image list screen has been explained. However, the user may specify the type of an image on the image list screen.

For example, when the user specifies “partial panoramic images 1” on the image list screen shown in FIG. 9, the images 903 to 905 may be automatically selected. Similarly, when the user specifies “partial panoramic images 2” on the image list screen shown in FIG. 10, the images 1001 to 1003 may be selected.

### Other Embodiments

The embodiments of the present invention have been described above in detail. The present invention is applicable, for example, to a system, an apparatus, a method, a program, or a storage medium (recording medium). More specifically, the present invention may be applied to a system including a plurality of apparatuses or may be applied to an apparatus constituted by a single device.

In an aspect of the present invention, a program of software implementing functions of the foregoing embodiments (in the embodiments, programs corresponding to the flowcharts shown in the drawings) is supplied to a system or an apparatus directly or from a remote external apparatus. An aspect of the present invention can be attained in a case where a computer of the system or the apparatus reads and executes the supplied program code.

Consequently, program code itself installed into the computer in order that functional processing of an aspect of the present invention can be implemented on the computer also implements the present invention. That is, the present invention also includes a computer program itself for implementing the functional processing of an aspect of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-212938, filed Aug. 21, 2008, which is hereby incorporated by reference herein in its entirety.

1. An image processing apparatus comprising:
an image specifying unit configured to specify at least one of a plurality of images included in a single file in accordance with an operation by a user;
an image selecting unit configured to select, in accordance with the type of the at least one image specified by the image specifying unit, another image from among the plurality of images based on the type of the specified at least one image; and
an output unit configured to output at least one of the at least one image specified by the image specifying unit and the other image selected by the image selecting unit.

2. The image processing apparatus according to claim 1, wherein the image selecting unit selects the other image in addition to the at least one image specified by the image specifying unit, the other image being of the same type as the specified at least one image.

3. The image processing apparatus according to claim 2, wherein in a case where the at least one image specified by the image specifying unit is a partial panoramic image, the image selecting unit selects, in addition to the specified at least one image, another partial panoramic image associated with the specified at least one image.

4. The image processing apparatus according to claim 1, further comprising:
a confirmation unit configured to, in a case where an image is specified by the image specifying unit, allow the user to confirm whether or not to select another image associated with the specified image,
wherein in a case where an instruction to select another image associated with the specified image has been issued by the user in accordance with a result of the confirmation using the confirmation unit,
the image selecting unit selects the other image associated with the specified image.

5. The image processing apparatus according to claim 4, wherein in a case where the image specified by the image specifying unit is a partial panoramic image, the confirmation unit allows the user to confirm whether or not to select another partial panoramic image associated with the specified image.

6. The image processing apparatus according to claim 4, wherein in a case where the image specified by the image specifying unit is a thumbnail image, the confirmation unit allows the user to confirm whether or not to select an original image of the specified thumbnail image.

7. The image processing apparatus according to claim 4, wherein in a case where a thumbnail image has been selected, when an original image of the thumbnail image is specified by the image specifying unit, the confirmation unit allows the user to confirm whether or not to cancel the selection of the thumbnail image.

8. The image processing apparatus according to claim 1, wherein in a case where a plurality of images are selected by the image selecting unit, the output unit outputs the selected plurality of images by using one of a first output method for outputting the selected plurality of images as a single file, a second output method for outputting the selected plurality of images as individual files, and a third output method for combining the selected plurality of images into an image and outputting the combined image.

9. The image processing apparatus according to claim 8, further comprising:
an output method determination unit configured to determine, in accordance with the types of the plurality of images selected by the image selecting unit, an output method that can be selected as the output method to be used for outputting the selected plurality of images.

10. The image processing apparatus according to claim 9, wherein the output method determination unit determines the third output method as the output method that can be selected in a case where the plurality of images selected by the image selecting unit only include partial panoramic images, and does not determine the third output method as the output method that can be selected in a case where the plurality of images selected by the image selecting unit include an image other than a partial panoramic image.

11. The image processing apparatus according to claim 1, further comprising:
a display unit configured to display a plurality of pieces of information,
the plurality of pieces of information respectively describing the plurality of images,
wherein the image specifying unit specifies the at least one image in accordance with the operation performed by the user on the basis of the plurality of pieces of information displayed on the display unit.

12. The image processing apparatus according to claim 11, wherein the display unit displays the plurality of pieces of information in such a manner that the type of each of the plurality of images can be identified.

13. The image processing apparatus according to claim 1, further comprising:
a file specifying unit configured to specify at least one of a plurality of files in accordance with an operation by the user;
an instruction unit configured to issue an instruction to display, on a display unit, a plurality of pieces of information, the plurality of pieces of information respectively describing a plurality of images included in the at least one file specified by the file specifying unit; and
an activating unit configured to activate the instruction unit in a case where the at least one file specified by the file specifying unit includes a plurality of images.

14. The image processing apparatus according to claim 1, further comprising:
a management unit configured to manage information describing the image selected by the image selecting unit and output by the output unit, in association with the original file including the output image.

15. The image processing apparatus according to claim 1, further comprising:
a holding unit configured to, in a case where the output unit outputs the image selected by the image selecting unit as one or more files, hold the output one or more files independently of the original file including the output image.

16. The image processing apparatus according to claim 1, wherein the output unit transmits the image selected by the image selecting unit to an external apparatus connected to the image processing apparatus via a network.

17. The image processing apparatus according to claim 1, wherein the output unit writes the image selected by the image selecting unit into a portable memory medium connected to the image processing apparatus.

18. A control method for an image processing apparatus, the control method comprising:
an image specifying step of specifying at least one of a plurality of images included in a single file in accordance with an operation by a user;
an image selecting step of selecting, in accordance with the type of the at least one image specified in the image specifying step, another image from among the plurality of images based on the type of the specified at least one image; and
an output step of outputting at least one of the at least one image specified in the image specifying step and the other image selected in the image selecting step.

19. A computer-readable storage medium having a program stored thereon, the program causing a computer to execute the control method according to claim 18.
